(19) United States
(12) Patent Application Publication
(10) Pub. No.: US 2012/0328728 A1
(43) Pub. Date: Dec. 27, 2012

(54) MOLD FOR IMPRINTING AND PRODUCTION METHOD THEREOF

(75) Inventors: Sakae Nakatsuka, Shinjuku-ku (JP); Isao Amemiya, Shinjuku-ku (JP); Ikuru Kimura, Shinjuku-ku (JP)

(73) Assignee: HOYA CORPORATION, Shinjuku-ku, Tokyo (JP)

(21) Appl. No.: 13/575,854

(22) PCT Filed: Jan. 27, 2011
(86) PCT No.: PCT/JP2011/051550

§ 371 Date: Sep. 10, 2012

(30) Foreign Application Priority Data
Jan. 29, 2010 (JP) 2010-019664

(51) Int. Cl. B29C 33/42; B29C 35/08

(52) U.S. Cl. 425/385; 264/400

(57) ABSTRACT

To provide an imprinting mold comprising: a flattening layer provided on a substrate, having a layer made of a flattening agent; and a layer having a fine pattern on the flattening layer.

### TECHNICAL FIELD

The present invention relates to an imprinting mold and a method of manufacturing the same, and more particularly to the imprinting mold and the method of manufacturing the same, capable of forming a fine pattern on a mold surface.

### DESCRIPTION OF RELATED ART

Conventionally, in a field of mechanical machining and an electronic circuit, machining of micron-order is carried out, and during control, etc., of the machining, it is conventionally general to use a visible light. However, in such a visible light, there is a limit that only the micron-order control can be carried out.

Meanwhile, in an apparatus called a stepper, machining of micron-order to nano-order of several tens nm is achieved by using light or electron beam having a shorter wavelength than the wavelength of the visible light from ultraviolet laser or an extreme ultraviolet light source.

Meanwhile, considerable time is required for forming a pattern even in a case of the machining of the micron-order. Therefore, the required time is further increased in a fine machining of the nano-order. In addition, when the ultraviolet laser or the extreme ultraviolet laser is used, a large-scale apparatus is required, thus increasing a cost. Further, the fine machining carried out by electron-beam exposure and development is a sequential machining, involving a problem that work efficiency is deteriorated.

Meanwhile, as a technique of transferring a mask pattern formed on a glass plate by exposure using ordinary light, namely photolithography can be given as a conventional technique of ordinary fine pattern transfer. However, even when the photolithography is used, the technique depends on a resolution of light, thus involving a problem that there is a limit in forming a fine pattern of nano-order.

In order to cope with this problem, in recent years, a nano-imprint technique has been focused, which is the technique of transferring the fine pattern on a material to be transferred like a stamp, using a mold having the fine pattern formed therein. Owing to such a nano-imprint technique, a fine structure of several tens nm level can be fabricated in large quantities at a low cost with good reproducibility.

Note that an imprint technique is largely classified into two kinds, such as thermal and optical imprinting. The thermal imprinting is a method of pressing the mold having the fine pattern formed therein, against a thermoplastic resin being a material to be molded while heating this thermoplastic resin, and thereafter cooling and separating the mold from the resin, to thereby transfer the fine pattern. Meanwhile, the optical imprinting is a method of pressing the mold having the fine pattern formed therein against a light curing resin being the material to be molded and irradiating it with ultraviolet light, and separating the material to be molded thereafter, to thereby transfer the fine pattern.

In using each imprint method, finer pattern needs to be transferred on a larger material to be molded. This requires a system such as a batch transfer system in which the mold and the material to be molded are pressed at once, a step & repeat system in which the imprint method is repeatedly carried out using a flat plate mold to thereby finally transfer the fine pattern on a substrate having a large area, and a roller system (for example see patent documents 1 and 2).

### PRIOR ART DOCUMENTS

### Patent Documents

Patent document 1:
Japanese Patent Laid Open Publication No. 2005-5284
Patent document 2:
Japanese Patent Laid Open Publication No. 2008-73902

### SUMMARY OF THE INVENTION

### Problem to be Solved by the Invention

In order to realize a fine pattern, a fine pattern needs to be provided on an imprint mold being a master mold. In order to form the fine pattern, means such as direct drawing on a fine pattern forming layer by blue laser or electron beam (EB), etc., and etching treatment applied to the fine pattern forming layer after drawing/developing the fine pattern on a resist, are used.

When such a drawing of the fine pattern is carried out, usually laser irradiation is performed after focusing on a surface of a substrate. However, when there is a scratch on the surface of the substrate, namely in a case of a low flatness of the surface of the substrate, focusing is adjusted to the substrate surface which is not flat. In this case, there is a possibility that shape reproducibility of the fine pattern is reduced when the drawing of the fine pattern is carried out.

It is true that drawing equipment is usually equipped with an autofocus function, thus hardly allowing a focus error to occur if the scratch is a nano-order level. However, in a case of a scratch of micron-order, there is a possibility that the focus error is generated even if the autofocus function is used. The focus error is responsible for a failure in reproducing the fine pattern stored in the drawing equipment, on an imprinting mold with good precision.

An object of the present invention is to provide an imprinting mold with reduced surface roughness of a substrate and as a result having a fine pattern with high pattern precision, and a method of manufacturing the same.

### Means for Solving the Problem

According to a first aspect of the present invention, there is provided an imprinting mold comprising:

a flattening layer provided on a substrate, having a layer made of a flattening agent; and

a layer having a fine pattern on the flattening layer.

According to a second aspect of the present invention, in the invention of the first aspect, the substrate is a cylindrical substrate made of stainless steel, and the flattening agent is polysilazane.

According to a third aspect of the present invention, in the invention of the first or second aspect, the layer having the fine pattern is a fine pattern forming layer, the fine pattern forming layer including a chromium oxide layer wherein thickness of the chromium oxide layer is larger than 100 nm and thickness of a whole body of the fine patter forming layer is larger than 100 nm and 1 μm or less.

According to a fourth aspect of the present invention, in the invention of the first or second aspect, the layer having the fine pattern is a fine pattern forming layer, the fine pattern forming layer including a chromium nitride layer, wherein thickness of the chromium nitride layer is 20 nm or more and thickness of a whole body of the fine pattern forming layer is 20 nm or more and 1 μm or less.

According to a fifth aspect of the present invention, in the invention of the first or second aspect, the layer having the fine pattern is a fine pattern forming layer, the fine pattern forming layer including a chromium oxide layer and a chromium nitride layer, wherein thickness of the chromium nitride layer is 20 nm or more and thickness of a whole body of the fine pattern forming layer is 20 nm or more and 1 μm or less.

According to a sixth aspect of the present invention, in the invention of the first or second aspect, the layer having the fine pattern is a fine pattern forming layer, the fine pattern forming layer including an amorphous carbon layer, wherein thickness of the amorphous carbon layer is larger than 50 nm and thickness of the fine pattern forming layer is larger than 50 nm and 1 μm or less.

According to a seventh aspect of the present invention, there is provided a method of manufacturing an imprinting mold, comprising

flattening a surface of a substrate by coating the substrate with a flattening agent.

According to an eighth aspect of the present invention, in the invention of the seventh aspect, the substrate is a cylindrical substrate made of stainless steel, and the flattening agent is polysilazane.

According to a ninth aspect of the present invention, in the invention of the seventh or eighth aspect, there is provided the method comprising:

providing a layer having a fine pattern forming layer on a flattening layer having a layer made of a flattening agent after flattening the surface of the substrate, and further providing a resist layer thereon for forming a fine pattern;

drawing and developing the fine pattern on the resist layer; and

etching the fine pattern forming layer and forming the fine pattern after drawing.

According to a tenth aspect of the present invention, in the invention of the ninth aspect, the fine pattern forming layer includes a chromium oxide layer, thickness of the chromium oxide layer is larger than 100 nm and thickness of a whole body of the fine pattern forming layer is larger than 100 nm and 1 μm or less.

According to an eleventh aspect of the present invention, in the invention of the ninth aspect, the fine pattern forming layer includes a chromium nitride layer, and thickness of the chromium nitride layer is 20 nm or more, and thickness of a whole body of the fine pattern forming layer is 20 nm or more and 1 μm or less.

According to a twelfth aspect of the present invention, in the invention of the ninth aspect, the fine pattern forming layer includes a chromium oxide layer and a chromium nitride layer, and thickness of the chromium nitride layer is 20 nm or more, and thickness of a whole body of the fine pattern forming layer is 20 nm or more and 1 μm or less.

According to a thirteenth aspect of the present invention, in the invention of the ninth aspect, the fine pattern forming layer includes an amorphous carbon layer, and thickness of the amorphous carbon layer is larger than 50 nm and thickness of the fine pattern forming layer is larger than 50 nm and 1 μm or less.

According to a fourteenth aspect of the present invention, in the invention of the ninth aspect, blue laser drawing is carried out in the drawing process.

### Advantage of the Invention

According to the present invention, surface roughness of a substrate is reduced, and as a result, an imprinting mold having a fine pattern with high pattern precision, and a method of manufacturing the same can be provided.

### BRIEF DESCRIPTION OF THE DRAWINGS

FIG. 1 is a view schematically showing a manufacturing process of an imprinting mold according to this embodiment.

FIG. 2 is a schematic view of the imprinting mold of this embodiment, wherein (a) is a perspective view, (b) is a front view, and (c) is a cross-sectional view of (b) taken along the line A-A′.

FIG. 3 is an outline view explaining for focusing at the time of drawing a fine pattern, wherein (a) shows an example of the present invention, and (b) is an outline view of a conventional example.

FIG. 4 is a photograph view showing a precision of the fine pattern in this example.

FIG. 5 is a photograph view showing the precision of the fine pattern in this example.

FIG. 6 is a photograph view showing the precision of the fine pattern in this example.

FIG. 7 is a photograph view showing the precision of the fine pattern in this example.

FIG. 8 is a photograph view showing the precision of the fine pattern in this example.

FIG. 9 is a photograph view showing the precision of the fine pattern in this example.

### DETAILED DESCRIPTION OF THE INVENTION

As described above, when imprint is carried out, it is important whether or not a fine pattern provided on a master mold or a sub-master mold, being an original mold, has a high pattern precision. Then, it is highly probable that such a high pattern precision is attributable to surface roughness of a substrate, namely flatness of the substrate.

Under such a circumstance, it is found by the inventors of the present invention, that the substrate being a basic portion of an imprinting mold is coated with a flattening agent and thereafter a fine pattern forming layer is provided thereon. Thus, it is also found that a flattened surface made of the flattening agent can be focused at the time of drawing the fine pattern. Further, it is found that the fine pattern forming layer having the fine pattern on the surface having high flatness can be formed, and as a result, the fine pattern can be formed with high precision.

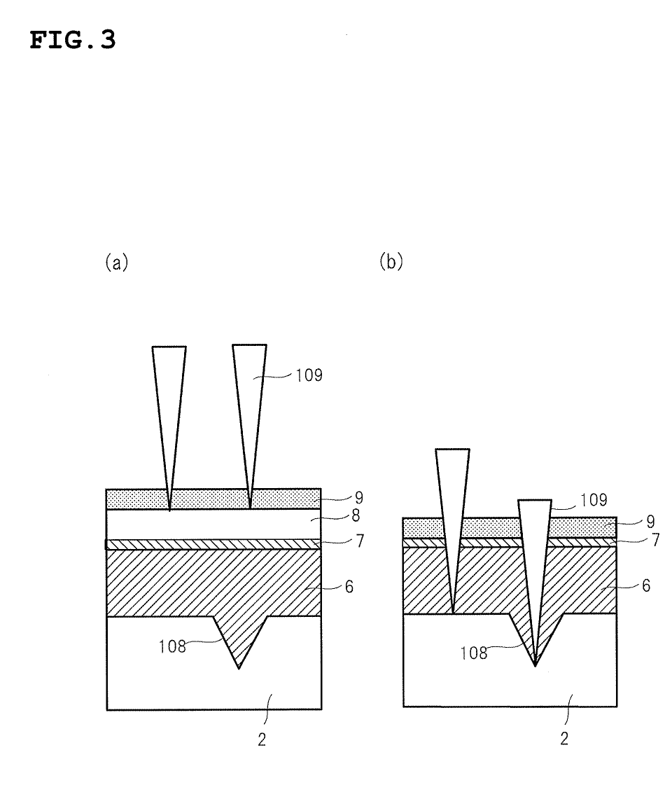

In addition, it is found by the inventors of the present invention, that a more opaque layer than a flattening layer is further provided on the flattening layer having a layer made of the flattening agent, as at least apart of a fine pattern forming layer 8. Thus, as shown in FIG. 3(a), it is found that the surface of the opaque layer can be surely focused at the time of drawing the fine pattern. Specifically, it is found that a situation as shown in FIG. 3(b) can be prevented. Namely, it is found that the following focus error can be prevented: a rough surface of the substrate across the flattening layer is focused at the time of drawing the fine pattern.

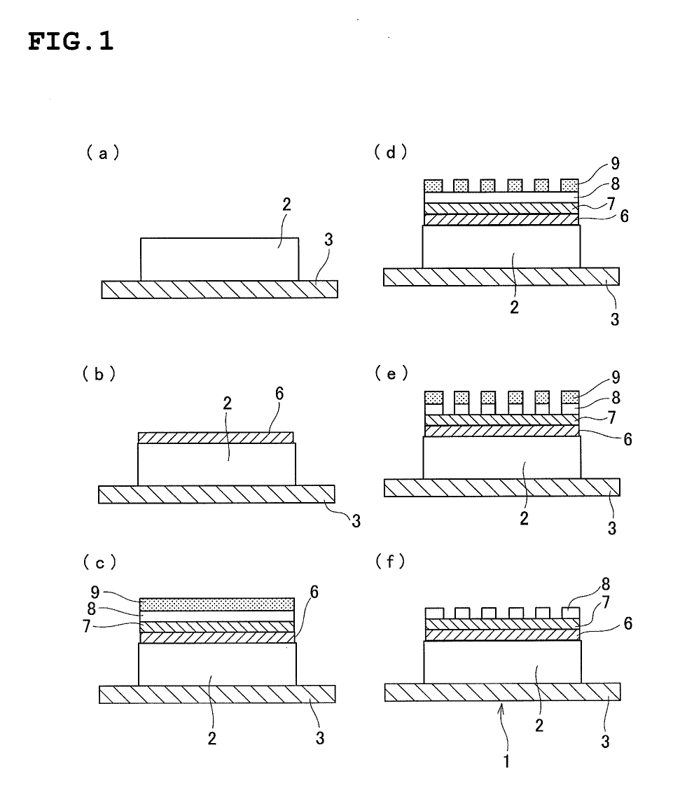

Embodiments for implementing the present invention will be described based on FIG. 1.

Note that according to this embodiment, “flatness (roundness or planarization)” is an index showing the surface roughness of a mold substrate, and showing a size of deviation from a geometric plane on the surface which is supposed to have no scratch, etc., and which is the index defined by JIS B 0182.

### Embodiment 1

FIG. 1 is a view schematically showing a manufacturing process of an imprinting mold 1 according to this embodiment (also simply called a mold 1 hereafter). FIG. 1(a) shows a mold substrate 2, and FIG. 1(b) shows a state that a flattening layer 6 made of a flattening agent is formed on the mold substrate 2. Further, FIG. 1(c) shows a state that an adhesion layer 7, a fine pattern forming layer 8, and a resist layer 9 are laminated on the flattening layer 6 in this order, and FIG. 1(d) shows a state that the fine pattern is drawn/developed on the resist layer 9. Further, FIG. 1(e) shows a state that etching is applied to the fine pattern forming layer 8, and FIG. 1(f) shows a state that cleaning is performed after etching, to thereby complete the mold 1. As shown in FIG. 1(f), the imprinting mold can be obtained, in which the flattening layer 6 is provided on the mold substrate 2, and the adhesion layer 7 and the fine pattern forming layer 8 having a fine pattern formed thereon, are provided on the flattening layer 6.

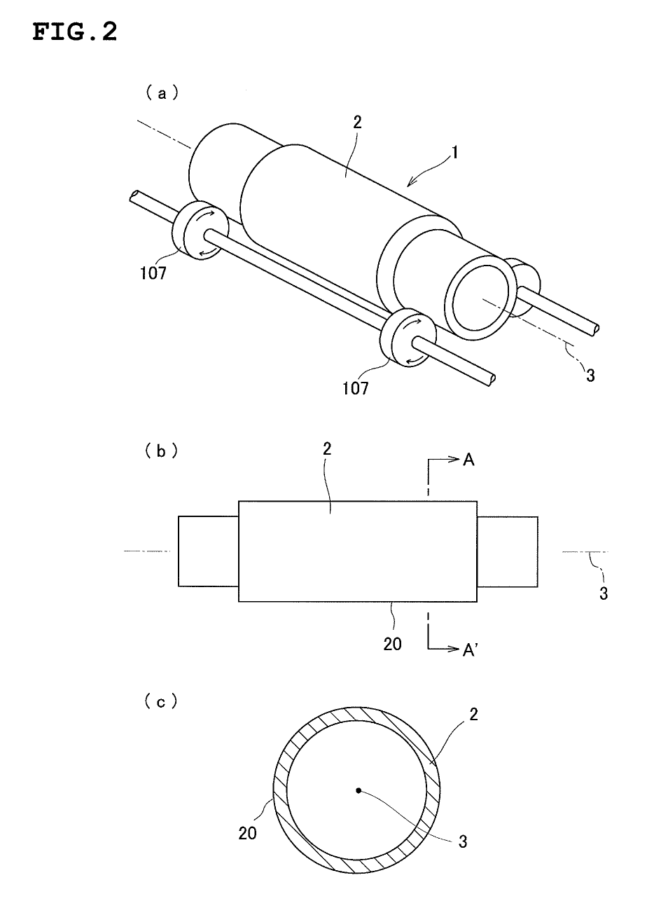

FIG. 2 is an overview diagram of the completed imprinting mold that has undergone such a process. Also, FIG. 2 is an outline view of the imprinting mold according to this embodiment, wherein (a) is a perspective view, (b) is a front view, and (c) is a cross-sectional view of (b) taken along the line A-A′. The imprinting mold and the method of manufacturing the same according to this embodiment will be described in detail hereafter based on FIG. 1 and FIG. 2.

(Preparation of the Substrate)

First, as shown in FIG. 1(a), the mold substrate 2 for the imprinting mold 1 is prepared.

The mold substrate 2 has any kind of composition, provided that it can be used as the imprinting mold 1. An alloy substrate such as metal or stainless steel can be given as the mold substrate 2, in consideration of industrial durability. Further, glass such as quartz, SiC, silicon wafer, and further a material with SiO layer provided on the silicon wafer, and carbon-based materials such as graphite, classy carbon, and carbon fiber reinforced plastics (CFRP), can be given in addition to the alloy substrate.

Further, the shape of the mold substrate is not limited, provided that it can be used as the imprinting mold. For example, a disc-shaped substrate and a cylindrical substrate can be given as the shape of the mold substrate 2. When the mold substrate 2 has a disc-shape, a disc mold substrate 2 can be uniformly coated with the flattening agent, etc., while being rotated, at the time of coating it with the flattening agent. Further, when the mold substrate 2 has a cylindrical shape, imprint by a roller system is enabled, and therefore the disc shape is suitable for mass production.

Note that the mold substrate 2 may have a shape other than the disc-shape, and may also have a rectangular shape, a polygonal shape, and a semi-circular shape. Further, the polygonal shape such as a column, a triangle pole and a square pole can be given as the shape of the mold substrate 2, wherein the column or the cylindrical shape is more preferable, because the fine pattern can be continuously and uniformly transferred to the material to be transferred. Note that according to this embodiment, the mold substrate 2 used as a base of manufacturing the imprinting mold is called a “substrate”, irrespective of its shape.

In this embodiment, the mold substrate 2 made of stainless steel having the cylindrical shape with its center formed as a hollow portion, is used for explanation hereafter. As shown in FIG. 2, the mold substrate 2 has right and left both sides mold end faces; a mold outer peripheral surface 20; and a rotary shaft 3 which is not formed materially.

### (Coating of the Flattening Agent)

As described above, the substrate used for the imprinting mold 1 has a problem that the scratch of micron order has a great influence on the reproducibility of the fine pattern.

Therefore, in this embodiment, the layer having the fine pattern is not directly formed on the surface of the mold substrate 2 as conventional, and the layer made of the flattening agent obtained by flatening a substrate surface by the flattening agent (also called a flattening layer 6 hereafter) is formed on the mold substrate 2. Such a flattening process applied to the substrate surface will be described hereafter in detail.

First, the flattening agent is selected. A conventionally used film flattening agent can be given as the flattening agent, and specifically polysilazane, methylsiloxane, and metal alkoxide, etc., can be given. Further, the aforementioned substances alone may be used, or a mixture of the aforementioned substances may also be used as the substances constituting the flattening layer 6, provided that satisfactory flatness can be maintained.

Next, the mold substrate 2 is held in a state that the rotary shaft 3 is set in a horizontal state, and a flattening agent containing vessel is prepared in a lower part of the mold substrate 2. Thereafter, the mold substrate 2 is lowered, so that a part of an outer peripheral surface of the mold substrate 2 is brought into contact with the flattening agent. Then, apart of the mold substrate 2 is dipped into the flattening agent.

Here, preferably the mold substrate 2 is brought into contact with the flattening agent in parallel to a direction of the rotary shaft. Owing to such a parallel contact, difference in coating degrees between the right and left both sides mold end faces, can be prevented from generating in a dip portion of the mold substrate 2. As a result, unevenness of the coating of the flattening agent is not allowed to occur.

Thus, the mold substrate 2 is rotated by a plurality of rollers 107, with the flattening agent and the mold substrate 2 set in a contact state in parallel to the direction of the rotary shaft, to thereby coat the mold outer peripheral surface 20 with the flattening agent (FIG. 1(b)). Note that as shown in FIG. 2(a), a portion for rotating the mold substrate 2 by the rollers 107 may also be separately provided on the mold substrate 2.

A rotating speed and number of rotations at this time are set so that the mold substrate 2 can be sufficiently coated with the flattening agent.

(Formation of the Fine Pattern)

According to this embodiment, the adhesion layer 7, the fine pattern forming layer 8, and the resist layer 9 are laminated in this order, on the flattening layer 6 made of the flattening agent coated as described above (FIG. 1(c)). Thereafter, electron beam exposure is performed to the resist layer 9, thus applying etching treatment thereto (FIG. 1(d), (e)). Thus, the fine pattern is formed on the fine pattern forming layer 8 on the mold substrate 2 (FIG. 1(f)).

First, the adhesion layer 7 is provided on the flattening layer 6, for bonding the fine pattern forming layer 8, the flattening layer 6, and consequently the mold substrate 2. Any kind of substance can be used as the adhesion layer 7. However, an amorphous silicon layer is preferably used. Note that the adhesion layer 7 may not be provided, provided that the fine pattern forming layer 8 can be satisfactorily bonded to the flattening layer 6, when forming the fine pattern forming layer 8 on the flattening layer 6. In this embodiment, explanation is given for a case that the adhesion layer 7 is provided on the flattening layer 6.

Regarding the fine pattern forming layer 8 provided on the adhesion layer 7, in this embodiment, at least a part of the fine pattern forming layer 8 is an opaque layer. Further, transmittance at a wavelength of 405 nm transmitted through the whole body of the fine pattern forming layer 8 having the opaque layer, is preferably set in a proper range. As shown in FIG. 3(a), when the mold substrate 2 having the fine pattern forming layer 8 laminated thereon, is irradiated with the laser beam 109 from above, focus of the laser beam 109 can be surely adjusted to the surface of the opaque layer during pattern drawing. More specifically, a circumstance as shown in FIG. 3(b) can be suppressed. Namely, although the mold substrate 2 is flattened by the flattening layer 6, the focus of the laser beam 109 during drawing the fine pattern, can be prevented from being adjusted to a portion of a scratch 108 on the rough surface of the substrate, across the flattening layer 6. Note that the inventors of the present invention studies on a proper range of the transmittance.

Note that the “opaque layer” in this embodiment means a layer which is opaque enough to carry out focusing on this opaque layer, when focusing of the pattern drawing is carried out from the substrate on which the fine pattern forming layer 8 is laminated. When the opaque layer is formed on a part of the fine pattern forming layer 8, the focusing is carried out on this opaque layer. Therefore, preferably the opaque layer is arranged on a main surface side of the fine pattern forming layer 8 (on a laser irradiation side and at a portion closer to the resist layer 9).

A chromium oxide layer (CrOx), a chromium nitride layer (CrNx), and an amorphous carbon layer, etc., can be specifically given as the opaque layer. These layers may be used as the fine pattern forming layer 8 itself.

Here, when the fine pattern forming layer 8 includes the chromium oxide layer, the thickness of the chromium oxide layer is more preferably set to larger than 100 nm and the thickness of the whole body of the fine pattern forming layer 8 is more preferably set to larger than 100 nm and 1 μm or less. Sufficient focusing can be carried out on the chromium oxide layer, if the thickness is 100 nm or more. The thickness of 1 μm or less is sufficient to be put to practical use of the pattern transfer.

Further, when the fine pattern forming layer 8 includes the chromium nitride layer, the thickness of the chromium nitride layer is preferably set to 20 nm or more, and the thickness of the whole body of the fine pattern forming layer 8 is preferably set to 20 nm or more and 1 μm or less. Note that the thickness of the chromium nitride layer is preferably set to 30 nm or more.

Further, when the fine pattern forming layer 8 is formed of the chromium oxide layer and the chromium nitride layer, the thickness of the chromium nitride layer is preferably set to 20 nm or more, and the thickness of the whole body of the fine pattern forming layer 8 is preferably set to 20 nm or more and 1 μm or less. In this case, the chromium nitride layer is more opaque than the chromium oxide layer, and therefore the chromium nitride layer mainly functions as the opaque layer. Accordingly, the chromium nitride layer is preferably formed on the chromium oxide layer in an order of lamination. Then, the focus of the laser beam 109 can be surely adjusted to the chromium nitride layer of an upper layer, thus making it possible to form a minute pattern by applying etching to the chromium oxide layer thereafter. Namely, a relatively opaque layer is preferably arranged on the upper layer of the fine pattern forming layer 8.

Note that the amorphous carbon layer may also be used, in addition to the chromium oxide layer and the chromium nitride layer. The amorphous carbon layer does not have a high transparency like the chromium oxide layer, and therefore focusing on the mold substrate 2 can be prevented during drawing the fine pattern. It is preferable to use the amorphous carbon layer, with its thickness set to larger than 50 nm and the thickness of the whole body of the fine pattern forming layer 8 set to larger than 50 nm and 1 μm or less.

When the thickness of the layer formed of the aforementioned each substance, is set in the aforementioned range, the focus of the laser beam 109 can be surely adjusted to the fine pattern forming layer 8 which is formed on the surface of the flattening layer 6. Further, when the thickness of the whole body of the fine pattern forming layer 8 is set in the aforementioned range, the focus can be surely adjusted to the fine pattern forming layer 8, and also the fine pattern having a proper aspect ratio can be formed.

Thereafter, as shown in FIG. 1(c), the resist layer 9 for blue laser drawing is formed on the fine pattern forming layer 8. A heat-sensitive material which changes in state by thermal change, and which is suitable for the etching thereafter, may be used as the resist layer 9 for blue laser drawing. Further, a sensitive material may also be used. At this time, an inorganic resist layer made of tungsten oxide (WOx) having gradient composition, is further preferable from a point that resolution can be improved.

Thereafter, by developing the mold substrate 2 having an already drawn resist layer 9, as shown in FIG. 1(d), the resist layer 9 having a desired fine pattern (namely a pattern inverted with respect to the fine pattern which is formed in a finally obtained product), can be obtained.

As described above, after forming the fine pattern on the resist layer 9, etching treatment is applied to the fine pattern forming layer 8, with the resist layer 9 as an etching mask. Thus, the fine pattern forming layer 8 having the fine pattern formed thereon can be formed on the mold substrate 2 made of stainless steel. In the etching treatment, a conventional technique may be used. Dry etching by chlorine gas and oxygen gas can be given for example.

By this dry etching, the mold substrate 2 with resist layer 9 having a desired fine pattern, can be obtained as shown in FIG. 1(e).

Alkali cleaning and steam seasoning by isopropanol are performed to the mold substrate 2 with resist layer 9, to thereby remove the resist layer 9. Thus, as shown in FIG. 1(f), the mold 1 with a desired fine pattern transferred to the outer peripheral surface 20 of the mold, can be fabricated.

Note that the fine pattern at this time may be the pattern of nano-order to micro-order, and a periodical structure of nano-order of several nm to several hundred nm is further preferable. Specifically, a line and space pattern, and a fine protrusion structure formed of a plurality of minute unevenness, can be given as an example. As a sectional shape thereof, triangle, trapezoid, and rectangle, etc., can be given in a case of a one-dimensional periodic structure. In a case of a two-dimensional periodic structure, not only an exact cone shape, (generating line is a straight line) and an exact pyramid shape (ridge line is a straight line), but also a curved surface may also be used in which the generating line and the ridge line are formed as curved lines and a side face is swollen outward, provided that the fine protrusion has a tapered shape in consideration of extraction after imprint. For example, a hanging bell, a circular cone, a circular truncated cone, and a column, etc., can be given specifically. A period of the periodic structure is called a pitch hereafter, thereby showing a distance between protrusion vertexes.

Further, a tip end portion may be flattened or rounded, in consideration of moldability and breakage resistance. In addition, continuous fine protrusions in one direction may be fabricated as the fine protrusions.

As described above, the imprinting mold according to this embodiment is formed. According to this embodiment, the following effect can be exhibited.

Namely, the surface of the substrate being a base portion of the imprint mold, is coated with the flattening agent so that the flattening layer is formed, and by forming thereon the fine pattern forming layer, the fine pattern can be formed on a flat surface.

As a result, the focus can be adjusted to a flat surface made of the flattening agent, during drawing the fine pattern. Further, the fine pattern forming layer 8 having the fine pattern formed on the surface having high flatness can be formed. As a result, the fine pattern can be formed with high precision.

In addition, by forming the opaque fine pattern forming layer on the flattening layer including the flattening agent, the focus can be surely adjusted to the surface of the opaque layer during drawing the fine pattern. Namely, it is possible to prevent a situation that the focus is adjusted to the rough surface of the substrate across the flattening layer during drawing the pattern, irrespective of the flattening of the substrate by the flattening layer. As a result, the fine pattern forming layer can be formed with further high precision.

### Embodiment 2

According to embodiment 1, the substance having high transparency was used as the flattening agent. However, according to this embodiment, the substance having opaqueness is used as the flattening agent. Thus, the focus during pattern drawing is prevented from being adjusted to the rough surface of the substrate, even if the opaque layer is not used on the fine pattern forming layer 8. Namely, since the flattening agent itself is opaque, the focus can be surely adjusted to the surface of the flattened layer 6 during pattern drawing. Therefore, the resist layer 9 having the fine pattern can also be directly formed on the flattening layer 6. Note that when the surface of the mold substrate 2 has a certain degree of flatness like the silicon wafer, the imprinting mold can be formed by forming the resist layer 9 having the fine pattern directly on the flattening layer 6.

The flattening agent added with pigment additive can be given for example as the flattening agent having opaqueness. Further, even when the substance having tranparency is used for the flattening agent, the flattening layer 6 may be formed in such a manner that a chromium layer is interposed between two layers made of polysilazane.

As described above, the embodiments of the present invention are given. However, the aforementioned disclosure content shows exemplary embodiments, and therefore the scope of the present invention is not limited to the aforementioned exemplary embodiments. The embodiments of the present invention can be variously modified based on the disclosure content of this specification by a skilled person, irrespective of whether or not being clearly described or suggested in this specification.

### EXAMPLES

### Example 1

The present invention will be more specifically described next, by showing examples.

A stainless cylindrical hollow mold substrate 2 (SUS304, having diameter of 100 nm, namely having a radius of 50 mm, out of which diameter of a hollow portion: 84 mm, and distance between mold end faces: 300 mm) was prepared.

Next, the flattening agent was prepared. Solution obtained by dissolving 20% of polysilazane into dibutyl ether, was used as the flattening agent. A vessel of the flattening agent having the polysilazane ether therein, was disposed in a lower part of the mold substrate 2.

Thereafter, the mold substrate 2 is brought into contact with the polysilazane solution. At this time, a part of the outer peripheral surface 20 of the mold is dipped into the flattening agent in a depth of 0.3 mm or less from a liquid face of the flattening agent.

In this state, the mold is rotated at a rotation speed of 32 rotations/minute by the separately provided rotary shaft 3, thus coating a whole surface of the outer peripheral surface 20 of the mold with the polysilazane solution. At this time, the surface of the cylindrical mold substrate 2 was coated with the polysilazane solution so that the flattening layer 6 had a thickness of 1.5 μm.

Thereafter, the cylindrical mold substrate 2 and the flattening agent were separated from each other, and the mold substrate 2 was dried while being rotated.

Next, the adhesion layer 7, the fine pattern forming layer 8 which was opaque by itself, and the inorganic resist layer 9 were laminated on the coated flattening layer 6 in this order. The amorphous silicon layer was formed as the adhesion layer 7, with a thickness of 30 nm.

The amorphous carbon layer was formed as the fine pattern forming layer 8, with a thickness of 200 nm. The tungsten oxide (WOx) layer was formed as the inorganic layer 9 by sputtering, with a thickness of 20 nm. Note that a compositional variation of the inorganic resist layer 9 in a depth direction was the gradient composition expressed by hollow mold substrate side x=0.95, and resist outermost surface side x=1.60. In order to form the inorganic resist layer 9, a flow ratio of Ar:O₂ was continuously varied using an ion beam sputtering method, to have a gradient of an oxygen concentration in the inorganic resist layer 9. Further, the composition of the inorganic resist layer 9 was analyzed using Rutherford Back Scattering Spectroscopy (RBS).

The fine pattern formed of line and space, was drawn on the inorganic resist layer 9, using a blue laser drawing device (wavelength of 405 nm). After drawing, etching treatment and cleaning treatment were applied thereto, to thereby fabricate the mold 1.

### Examples 2 to 9

In examples 2 to 9, as shown in table 1, the mold 1 was fabricated similarly to example 1, excluding a point that the kind of the mold substrate 2, and the kind and the thickness of the fine pattern forming layer 8, were changed respectively.

Note that in example 3, the fine pattern forming layer 8 was not provided, and a completed mold was obtained by drawing and developing the fine pattern on the inorganic resist layer 9. Further, in example 6, the fine pattern not formed of line and space, but formed of dots, was drawn.

In fabricating the fine pattern forming layer 8, the flow rate was set to Ar:O₂=80:20 for forming the chromium oxide layer, and the flow rate was set to Ar:N₂=30:70 for further forming the chromium nitride layer thereon.

TABLE 1

| | | | Fine pattern | |
|---|---|---|---|---|
| | | Thickness of | forming layer | |
| | Kind of substrate | flattening layer | and thickness | Focus |
| Example 1 | SUS BA finish | Polysilazane | Amorphous | OK |
| | | 1.5 μm | carbon 200 nm | |
| Example 2 | SUS ECB finish | Polysilazane | Amorphous | OK |
| | | 1.5 μm | carbon 200 nm | |
| Example 3 | Silicon wafer mirror | Polysilazane | — | OK |
| | finish | 1.5 μm | | |
| Example 4 | SUS BA finish | Polysilazane | Chromium | OK |
| | | 1.5 μm | oxide 200 nm | |
| Example 5 | SUS BA finish | Polysilazane | Chromium | OK |
| | | 1.5 μm | nitride 30 nm | |
| Example 6 | SUS BA finish | Polysilazane | Chromium | OK |
| | | 1.5 μm | oxide 150 nm/ | |
| | | | Chromium | |
| | | | nitride 30 nm | |
| Example 7 | SUS BA finish | Polysilazane | Chromium | OK |
| | | 1.5 μm | oxide 30 nm/ | |
| | | | Chromium | |
| | | | nitride 30 nm | |
| Example 8 | SUS BA finish | Polysilazane | Chromium | OK |
| | | 1.5 μm | nitride 100 nm | |
| Example 9 | SUS BA finish | Polysilazane | Chromium | OK |
| | | 1.5 μm | nitride 20 nm | |

ECB finish: Compound electrolytic polishing finish

<Result>

Observation by a scanning electron microscope was performed to the mold manufactured in this example. Presence/absence of focusing abnormality was examined based on an observation result.

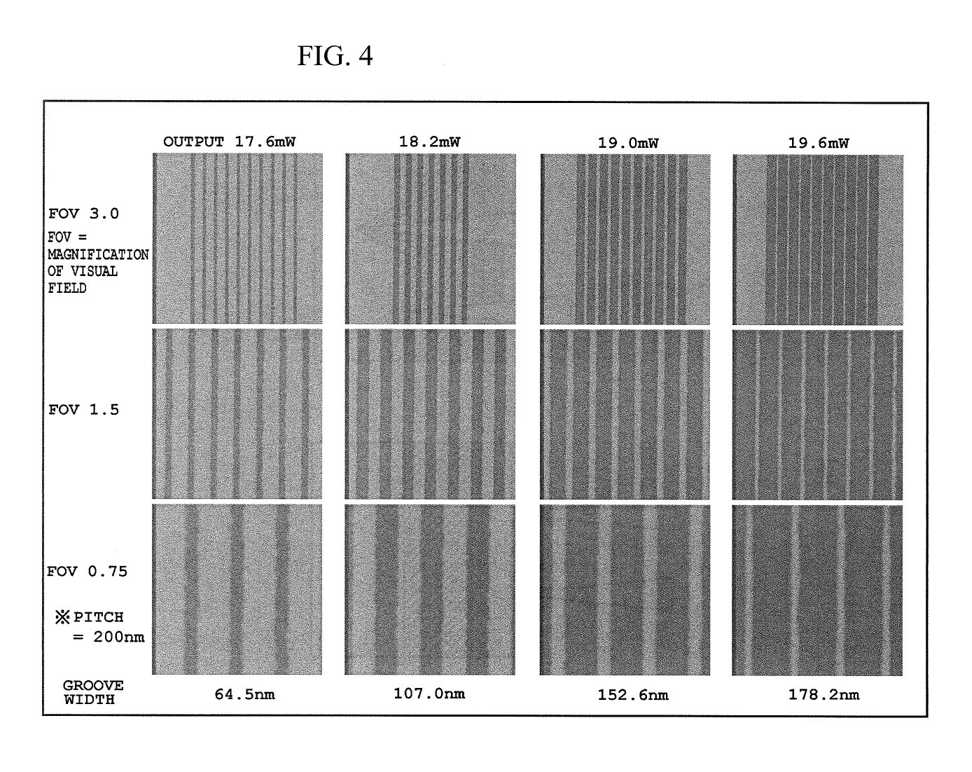

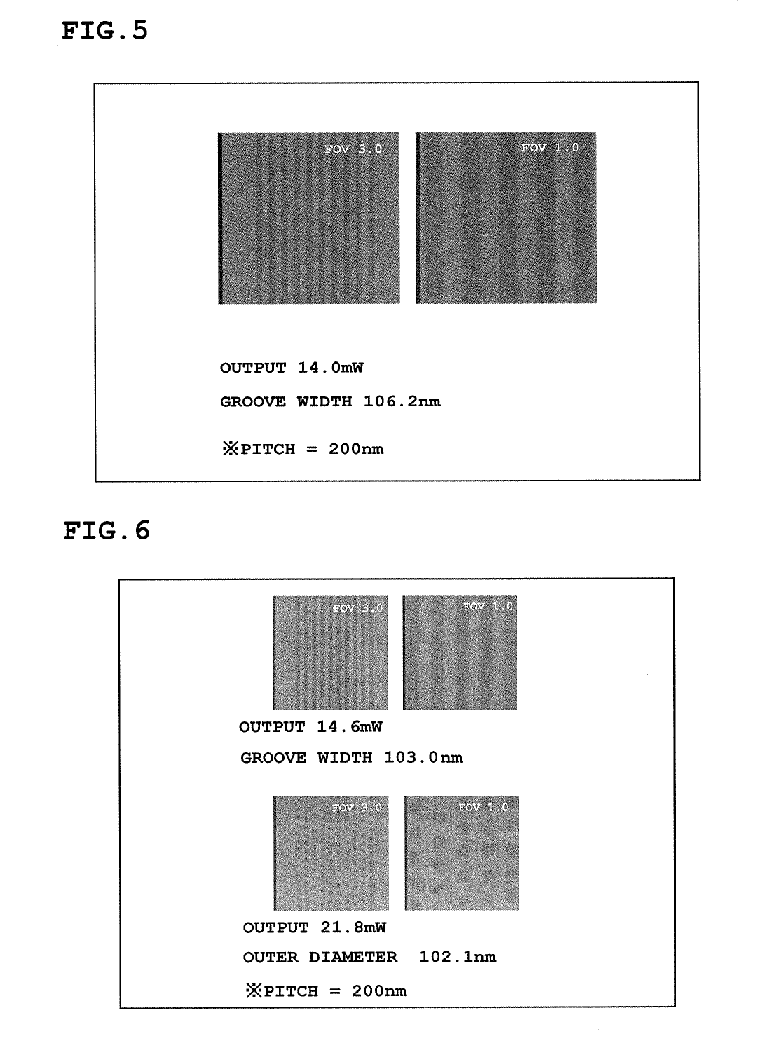

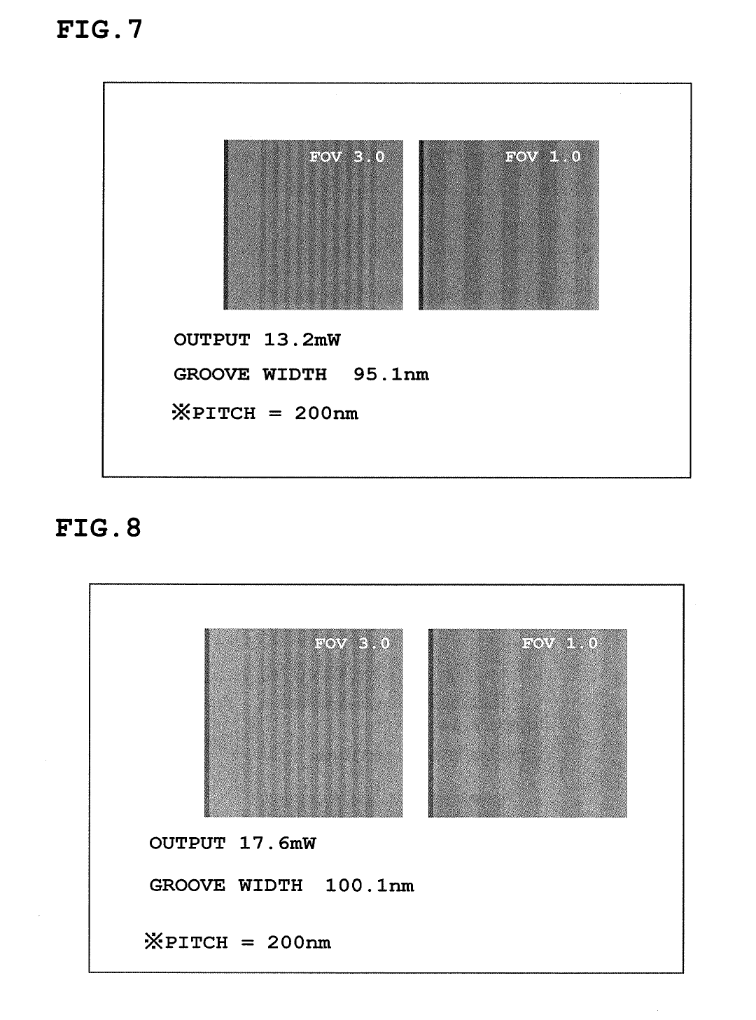

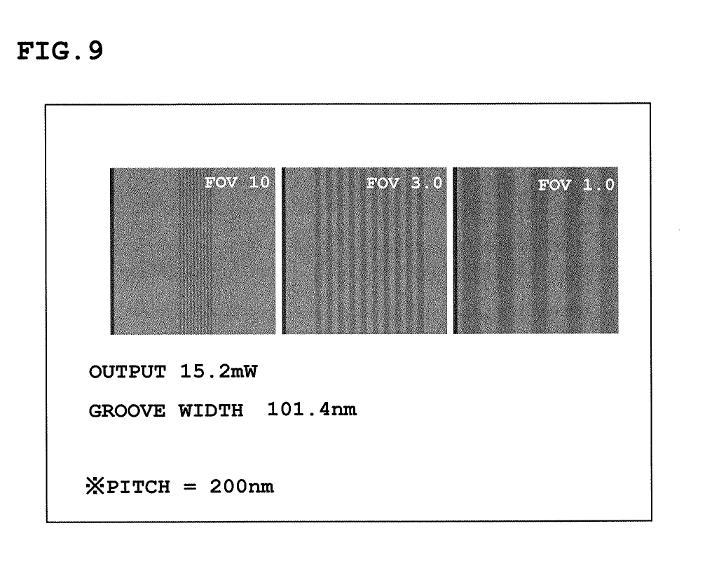

As a result, as shown in table 1, the focusing abnormality was not generated in examples 1 to 9. FIG. 4 shows a photograph showing a state of observing these examples, and shows the photograph of the mold of example 3 by the scanning electron microscope. Further, FIG. 5 shows the mold of example 4, FIG. 6 shows the mold of example 5, FIG. 7 shows the mold of example 7, FIG. 8 shows the mold of example 8, and FIG. 9 shows the mold of example 9. As is clarified from this photograph, the mold having the fine pattern formed therein with high precision can be obtained.

### DESCRIPTION OF SIGNS AND NUMERALS

1 Imprinting mold
2 Mold substrate
20 Mold outer peripheral surface
3 Rotary shaft
6 Flattening layer
7 Adhesion layer
8 Fine pattern forming layer
9 Resist layer
107 Roller
108 Scratch
109 Laser beam

1. An imprinting mold comprising:
a flattening layer provided on a substrate, having a layer made of a flattening agent; and
a layer having a fine pattern on the flattening layer.

2. The imprinting mold according to claim 1, wherein the substrate is a cylindrical substrate made of stainless steel, and the flattening agent is polysilazane.

3. The imprinting mold according to claim 1, wherein the layer having the fine pattern is a fine pattern forming layer, the fine pattern forming layer including a chromium oxide layer wherein thickness of the chromium oxide layer is larger than 100 nm and thickness of a whole body of the fine patter forming layer is larger than 100 nm and 1 μm or less.

4. The imprinting mold according to claim 1, wherein the layer having the fine pattern is a fine pattern forming layer, the fine pattern forming layer including a chromium nitride layer, wherein thickness of the chromium nitride layer is 20 nm or more and thickness of a whole body of the fine pattern forming layer is 20 nm or more and 1 μm or less.

5. The imprinting mold according to claim 1, wherein the layer having the fine pattern is a fine pattern forming layer, the fine pattern forming layer including a chromium oxide layer and a chromium nitride layer, wherein thickness of the chromium nitride layer is 20 nm or more and thickness of a whole body of the fine pattern forming layer is 20 nm or more and 1 μm or less.

6. The imprinting mold according to claim 1, wherein the layer having the fine pattern is a fine pattern forming layer, the fine pattern forming layer including an amorphous carbon layer, wherein thickness of the amorphous carbon layer is larger than 50 nm and thickness of the fine pattern forming layer is larger than 50 nm and 1 μm or less.

7. A method of manufacturing an imprinting mold, comprising
flattening a surface of a substrate by coating the substrate with a flattening agent.

8. The method of manufacturing the imprinting mold according to claim 7, wherein
the substrate is a cylindrical substrate made of stainless steel, and the flattening agent is polysilazane.

9. The method according to claim 7, comprising:
providing a layer having a fine pattern forming layer on a flattening layer having a layer made of a flattening agent after flattening the surface of the substrate, and further providing a resist layer thereon for forming a fine pattern;
drawing and developing the fine pattern on the resist layer; and
etching the fine pattern forming layer and forming the fine pattern after drawing.

10. The method according to claim 9, wherein the fine pattern forming layer includes a chromium oxide layer, thickness of the chromium oxide layer is larger than 100 nm and thickness of a whole body of the fine pattern forming layer is larger than 100 nm and 1 μm or less.

11. The method according to claim 9, wherein the fine pattern forming layer includes a chromium nitride layer, and thickness of the chromium nitride layer is 20 nm or more, and thickness of a whole body of the fine pattern forming layer is 20 nm or more and 1 μm or less.

12. The method according to claim 9, wherein the fine pattern forming layer includes a chromium oxide layer and a chromium nitride layer, and thickness of the chromium nitride layer is 20 nm or more, and thickness of a whole body of the fine pattern forming layer is 20 nm or more and 1 μm or less.

13. The method according to claim 9, wherein the fine pattern forming layer includes an amorphous carbon layer, and thickness of the amorphous carbon layer is larger than 50 nm and thickness of the fine pattern forming layer is larger than 50 nm and 1 μm or less.

14. The method according to claim 9, wherein blue laser drawing is carried out in the drawing process.

15. The imprinting mold according to claim 2, wherein the layer having the fine pattern is a fine pattern forming layer, the fine pattern forming layer including a chromium oxide layer wherein thickness of the chromium oxide layer is larger than 100 nm and thickness of a whole body of the fine patter forming layer is larger than 100 nm and 1 μm or less.

16. The imprinting mold according to claim 2, wherein the layer having the fine pattern is a fine pattern forming layer, the fine pattern forming layer including a chromium nitride layer, wherein thickness of the chromium nitride layer is 20 nm or more and thickness of a whole body of the fine pattern forming layer is 20 nm or more and 1 μm or less.

17. The imprinting mold according to claim 2, wherein the layer having the fine pattern is a fine pattern forming layer, the fine pattern forming layer including a chromium oxide layer and a chromium nitride layer, wherein thickness of the chromium nitride layer is 20 nm or more and thickness of a whole body of the fine pattern forming layer is 20 nm or more and 1 μm or less.

18. The imprinting mold according to claim 2, wherein the layer having the fine pattern is a fine pattern forming layer, the fine pattern forming layer including an amorphous carbon layer, wherein thickness of the amorphous carbon layer is larger than 50 nm and thickness of the fine pattern forming layer is larger than 50 nm and 1 μm or less.

19. The method according to claim 8, comprising:
providing a layer having a fine pattern forming layer on a flattening layer having a layer made of a flattening agent after flattening the surface of the substrate, and further providing a resist layer thereon for forming a fine pattern;
drawing and developing the fine pattern on the resist layer; and
etching the fine pattern forming layer and forming the fine pattern after drawing.

20. The method according to claim 19, wherein the fine pattern forming layer includes a chromium oxide layer, thickness of the chromium oxide layer is larger than 100 nm and thickness of a whole body of the fine pattern forming layer is larger than 100 nm and 1 μm or less.

21. The method according to claim 19, wherein the fine pattern forming layer includes a chromium nitride layer, and thickness of the chromium nitride layer is 20 nm or more, and thickness of a whole body of the fine pattern forming layer is 20 nm or more and 1 μm or less.

22. The method according to claim 19, wherein the fine pattern forming layer includes a chromium oxide layer and a chromium nitride layer, and thickness of the chromium nitride layer is 20 nm or more, and thickness of a whole body of the fine pattern forming layer is 20 nm or more and 1 μm or less.

23. The method according to claim 19, wherein the fine pattern forming layer includes an amorphous carbon layer, and thickness of the amorphous carbon layer is larger than 50 nm and thickness of the fine pattern forming layer is larger than 50 nm and 1 μm or less.

24. The method according to claim 19, wherein blue laser drawing is carried out in the drawing process.
